(19) United States
(12) Patent Application Publication
(10) Pub. No.: US 2013/0215300 A1
(43) Pub. Date: Aug. 22, 2013

(54) IMAGE PICKUP DEVICE

(71) Applicant: Canon Kabushiki Kaisha, (US)

(72) Inventors: Masahiro Kobayashi, Tokyo (JP); Yuichiro Yamashita, Hsinchu (TW); Takeshi Kojima, Kawasaki-shi (JP); Itsutaku Sano, Tokyo (JP)

(73) Assignee: CANON KABUSHIKI KAISHA, Tokyo (JP)

(21) Appl. No.: 13/766,001

(22) Filed: Feb. 13, 2013

(30) Foreign Application Priority Data
Feb. 17, 2012 (JP) 2012-033364

(51) Int. Cl. H04N 5/335

(52) U.S. Cl. CPC H04N 5/335
USPC 348/294

(57) ABSTRACT

The present invention includes a photoelectric conversion unit, an amplifying element, a signal holding portion, and a charge transfer portion. The photoelectric conversion unit includes a first-conductivity-type first semiconductor region and a second-conductivity-type second semiconductor region. The signal holding portion includes a first-conductivity-type third semiconductor region and a control electrode disposed above the third semiconductor region via an insulator film. The second semiconductor region has a plurality of regions disposed at different depths. The plurality of regions has a first region that forms a PN junction with the first semiconductor region, a second region disposed at a position deeper than the first region, and a third region disposed between the first region and the second region. The impurity concentration peak P1 of the first region, the impurity concentration peak P2 of the second region, and the impurity concentration peak P3 of the third region satisfy P3<P1<P2.

### BACKGROUND OF THE INVENTION

1. Field of the Invention

The present invention relates to an image pickup device, and in particular, to a configuration in which pixels each have a signal holding portion.

2. Description of the Related Art

Pixel-amplification-type image pickup devices in which pixels each have an amplifying element are known in the related art. Each of the pixels of the pixel-amplification-type image pickup devices can hold a signal with a photoelectric conversion unit and the input node of the amplifying element. For such pixel-amplification-type image pickup devices, a global electronic shutter technique that allows the exposure period for the whole image pickup surface to be equal has been developed. There are known configurations for achieving the global electronic shutter. In particular, a configuration in which a signal holding portion is provided in an electric path between the photoelectric conversion unit and the input node of the amplifying element is known (Japanese Patent Laid-Open No. 2004-111590, Japanese Patent Laid-Open No. 2008-004692, and Japanese Patent Laid-Open No. 2011-082425).

For the configuration in which the signal holding portion is provided in the electric path between the photoelectric conversion unit and the input node of the amplifying element, no sufficient study has been made on the transfer of electric charges from the photoelectric conversion unit to the input node of the amplifying element at a low voltage. In particular, for transfer from the photoelectric conversion unit to the signal holding portion, no sufficient study has been made on the transfer of electrical charges from the photoelectric conversion unit to the signal holding portion at a low voltage while maintaining sensitivity at the photoelectric conversion unit.

In consideration of such problems, an embodiment of the present invention provides a configuration in which reduction in the sensitivity of a photoelectric conversion unit can be suppressed also when pixels have a plurality of signal holding portions in addition to the photoelectric conversion unit and the input node of the amplifying element. Furthermore, the present invention provides an image pickup device in which electrical charges can be transferred from the photoelectric conversion unit to the signal holding portion at a low voltage.

### SUMMARY OF THE INVENTION

The present invention provides an image pickup device comprising a plurality of pixels including a photoelectric conversion unit; an amplifying element that amplifies a signal based on a signal charge generated at the photoelectric conversion unit; a signal holding portion disposed on an electric path between an output node of the photoelectric conversion unit and an input node of the amplifying element; and a charge transfer portion that is disposed on an electric path between the output node of the photoelectric conversion unit and an input node of the signal holding portion and that transfers the signal charge at the photoelectric conversion unit to the signal holding portion, wherein the photoelectric conversion unit includes a first-conductivity-type first semiconductor region having the same polarity as that of the signal charge and a second-conductivity-type second semiconductor region; the signal holding portion includes a first-conductivity-type third semiconductor region and a control electrode disposed above the third semiconductor region via an insulator film, and the second semiconductor region includes a plurality of regions disposed at different depths, the plurality of regions including a first region that forms a PN junction with the first semiconductor region, a second region disposed at a depth deeper than the first region, and a third region disposed between the first region and the second region; and wherein P3<P1<P2 is satisfied, where P1 is the impurity concentration peak of the first region, P2 is the impurity concentration peak of the second region, and P3 is the impurity concentration peak P3 of the third region.

Further features of the present invention will become apparent from the following description of exemplary embodiments with reference to the attached drawings.

### BRIEF DESCRIPTION OF THE DRAWINGS

FIG. 1 is an overall block diagram of an image pickup device that can be applied to an embodiment of the present invention;

FIG. 2 is an equivalent circuit diagram of an image pickup device that can be applied to an embodiment of the present invention;

FIG. 3 is a diagram of control pulses supplied to an image pickup region of an image pickup device that can be applied to an embodiment of the present invention;

FIG. 4A is a potential diagram of a pixel of an image pickup device that can be applied to an embodiment of the present invention;

FIG. 4B is a potential diagram of the pixel of the image pickup device that can be applied to an embodiment of the present invention;

FIG. 4C is a potential diagram of the pixel of the image pickup device that can be applied to an embodiment of the present invention;

FIG. 4D is a potential diagram of the pixel of the image pickup device that can be applied to an embodiment of the present invention;

FIG. 4E is a potential diagram of the pixel of the image pickup device that can be applied to an embodiment of the present invention;

FIG. 4F is a potential diagram of the pixel of the image pickup device that can be applied to an embodiment of the present invention;

FIG. 4G is a potential diagram of the pixel of the image pickup device that can be applied to an embodiment of the present invention;

FIG. 5 is a top view of an image pickup device according to a first embodiment of the present invention;

FIG. 6 is a cross-sectional view taken along line XI-XI in FIG. 5;

FIG. 7A is a diagram showing the impurity concentration distribution of a cross section VIIA-VIIA in FIG. 6;

FIG. 7B is a potential diagram of FIG. 7A;

FIG. 7C is a diagram showing an impurity concentration distribution of a cross section VIIC-VIIC in FIG. 6;

FIG. 7D is a potential diagram of FIG. 7C;

FIG. 8 is a top view of an image pickup region of an image pickup device according to a second embodiment of the present invention;

FIG. 9 is a cross-sectional view taken along line IX-IX in FIG. 8;

FIG. 10A is a diagram showing the impurity concentration distribution of a cross section XA-XA in FIG. 9;

FIG. 10B is a potential diagram of FIG. 10A;

FIG. 10C is a diagram showing the impurity concentration distribution of a cross section XC-XC in FIG. 9;

FIG. 10D is a potential diagram of FIG. 10C;

FIG. 11 is a top view of an image pickup region of an image pickup device according to a third embodiment of the present invention;

FIG. 12 is a cross-sectional view taken along line XII-XII in FIG. 11;

FIG. 13A is a diagram showing the impurity concentration distribution of a cross section XIIIA-XIIIA in FIG. 12;

FIG. 13B is a potential diagram of FIG. 13A;

FIG. 13C is a diagram showing the impurity concentration distribution of a cross section XIIIC-XIIIC in FIG. 12;

FIG. 13D is a potential diagram of FIG. 13C; and

FIG. 14 is a diagram of an imaging system that can be applied an embodiment of the present invention.

### DESCRIPTION OF THE EMBODIMENTS

An embodiment of the present invention relates to a pixel-amplification-type image pickup device whose pixels each have an amplifying element. Specifically, an image pickup device according to an embodiment of the present invention has a signal holding portion disposed on an electric path between an output node of a photoelectric conversion unit and an input node of an amplifying element of a pixel.

Such a configuration provides a pixel configuration that allows global electronic shutter and can enhance the sensitivity of the pixels.

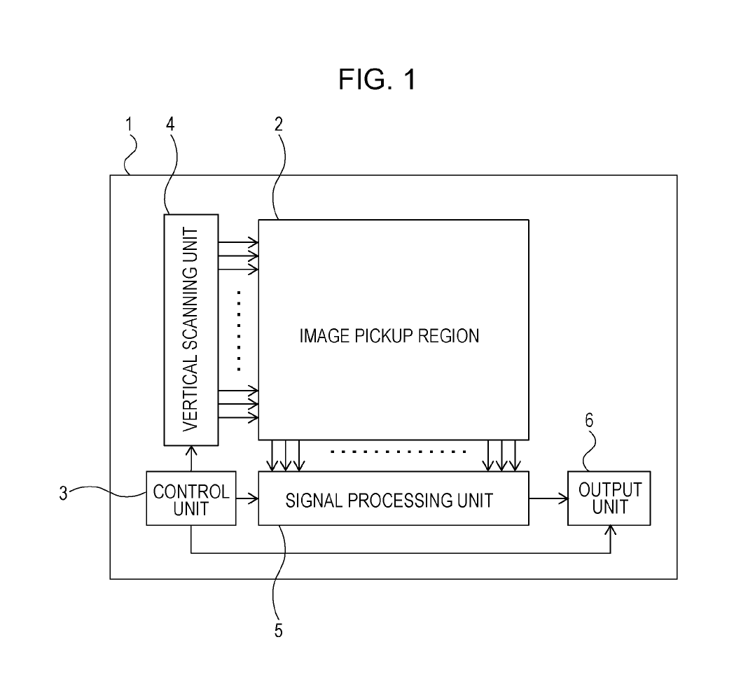

Referring to FIG. 1, an example of an overall block diagram of an image pickup device that can be applied to an embodiment of the present invention will be described. An image pickup device 1 can be constituted of a single chip on a semiconductor substrate. The image pickup device 1 includes an image pickup region 2 in which a plurality of pixels are disposed. The image pickup device 1 further includes a control unit 3. The control unit 3 supplies control signals, a power source voltage, and so on to a vertical scanning unit 4, a signal processing unit 5, and an output unit 6.

The vertical scanning unit 4 supplies driving pulses to the pixels disposed in the image pickup region 2. The driving pulses are normally provided to the individual pixel rows or every plurality of pixel rows. The vertical scanning unit 4 can be constituted of a shift register or an address decoder.

The signal processing unit 5 includes a column circuit, a horizontal scanning circuit, and a horizontal output line. The column circuit is constituted of a plurality of circuit blocks each receiving signals of a plurality of pixels in a pixel row selected by the vertical scanning unit 4. The circuit blocks can each be constituted of any or all of a signal holding portion, an amplifying circuit, a noise reduction circuit, and an analog-to-digital conversion circuit or a combination thereof. The horizontal scanning circuit can be constituted of a shift register or an address decoder.

The output unit 6 outputs signals transmitted via the horizontal output line to the outside of the mage pickup device 1. The output unit 6 includes a buffer or an amplifying circuit.

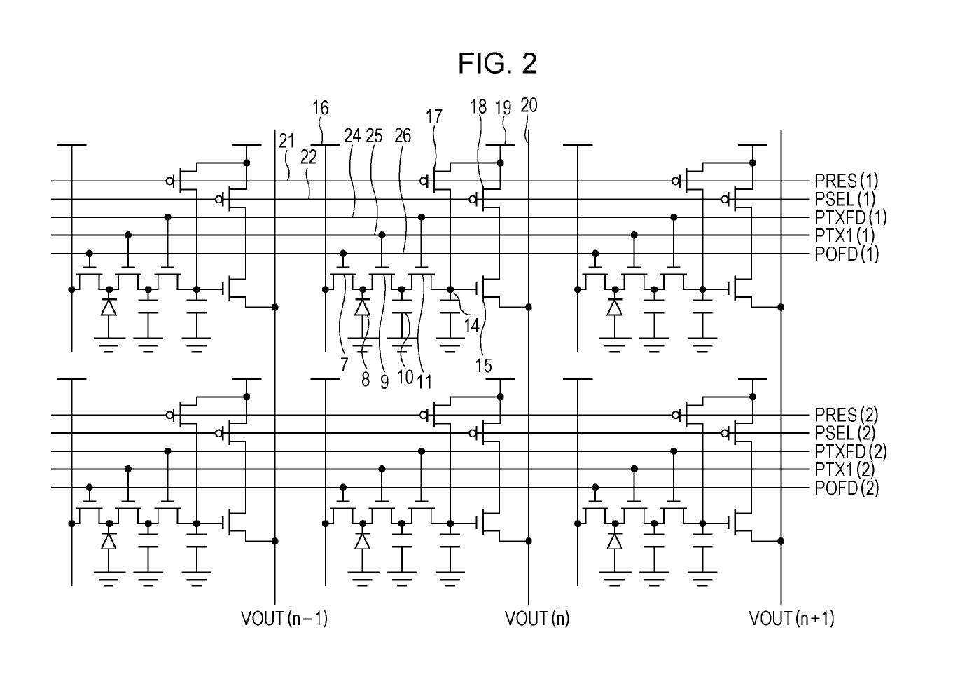

FIG. 2 shows an equivalent circuit of an image pickup region of an image pickup device that can be applied to an embodiment of the present invention. Although 2- by 3-pixels, six pixels in total, are shown here, the image pickup region may include more pixels.

A photoelectric conversion unit 8 converts incident light to hole-electron pairs. An O-node is an output node of the photoelectric conversion unit 8. A photodiode is shown as an example of the photoelectric conversion unit 8.

A first charge transfer portion 9 transfers holes or electrons generated by the photoelectric conversion unit 8 to a downstream circuit element. The first charge transfer portion 9 is disposed on an electric path between the output node, O-node, of the photoelectric conversion unit 8 and an input node of a signal holding portion 10. The following description is made using an example in which electrons are used as signal charges.

The signal holding portion 10 holds electrons generated by the photoelectric conversion unit 8. A second charge transfer portion 11 transfers the electrons held by the signal holding portion 10 to a downstream circuit element. The second charge transfer portion 11 is disposed on an electric path between an output node of the signal holding portion 10 and an input node 14 of an amplifying element 15.

The input node 14 of the amplifying element 15 is configured to be able to hold the electrons transferred from the signal holding portion 10 via the second charge transfer portion 11. The input node 14 of the amplifying element 15 can include a floating diffusion region (FD region) disposed on the semiconductor substrate. The amplifying element 15 amplifies a signal based on the electrons transferred to the input node 14 and outputs the signal to a vertical signal line 20. Here, a transistor (hereinafter referred to as an amplifying transistor) is used as the amplifying element 15. For example, the amplifying transistor 15 performs a source follower operation.

A third charge transfer portion 7 transfers the electrons at the photoelectric conversion unit 8 to an overflow drain region (OFD region) 112. An example of the OFD region is an N-type semiconductor region that is electrically connected to a voltage wire line 16 for supplying a source voltage.

A reset portion 17 supplies a reference voltage to the input node 14 of the amplifying element 15. The reset portion 17 resets electrons held at the input node 14 of the amplifying element 15. Here, a transistor (hereinafter referred to as a reset transistor) is used as the reset portion 17.

A select portion 18 selects pixels and reads signals from the pixels to the vertical signal line 20 for each of the pixels or pixel rows. Here, a transistor (hereinafter referred to as a select transistor) is used as the select portion 18.

The drain of the reset transistor 17 and the drain of the select transistor 18 are supplied with a predetermined voltage via a source-voltage supply wire line 19.

A reset control wire line 21 supplies a control pulse to the gate of the reset transistor 17. A selection control wire line 22 supplies a control pulse to the gate of the select transistor 18. A second transfer control wire line 24 supplies a control pulse to a control gate (hereinafter referred to as a second control gate) that constitutes the second charge transfer portion 11. A first transfer control wire line 25 supplies a control pulse to a control gate (hereinafter referred to as a first control gate) that constitutes the first charge transfer portion 9. A third charge-transfer control wire line 26 supplies a control pulse to a control electrode (hereinafter referred to as a third control gate) that constitutes the third charge transfer portion 7. The heights of the potential barriers of the semiconductor regions under the individual control gates can be changed with the values of the pulses supplied to the individual control gates.

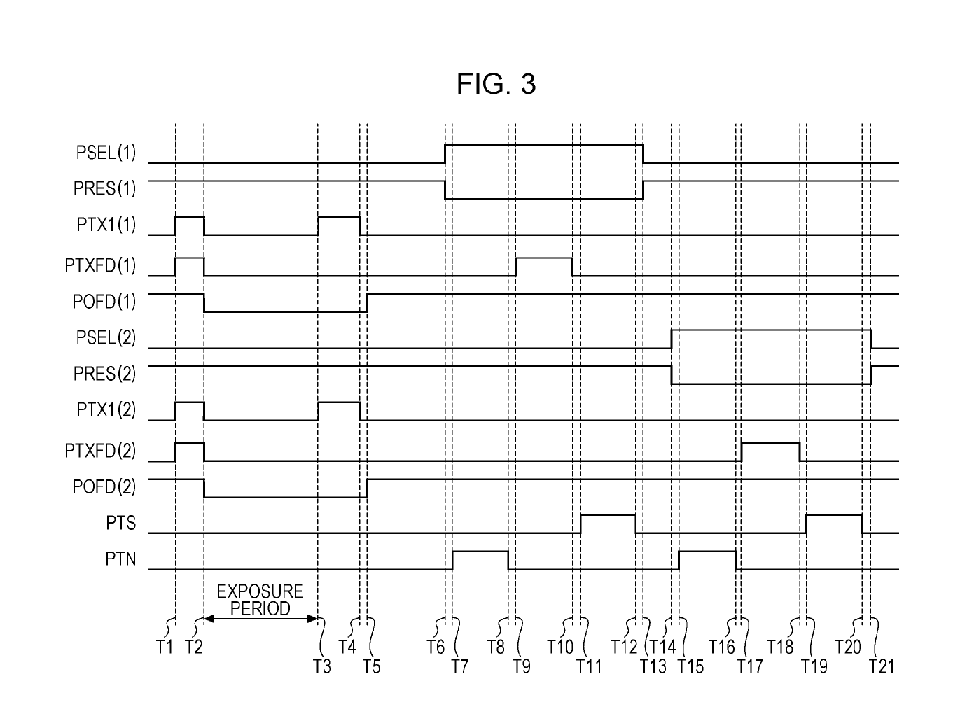

PSEL indicates a driving pulse supplied to the gate of the select transistor 18. PRES indicates a driving pulse supplied to the gate of the reset transistor 17. PTX1 indicates a driving pulse supplied to a first charge transfer gate. PTXFD indicates a driving pulse supplied to a second charge transfer gate. POFD1 indicates a driving pulse supplied to a third charge transfer gate. PTS (see FIG. 3) indicates a driving pulse for sampling and holding an optical signal with the signal holding portion 10 disposed in the column circuit. PTN (see FIG. 3) indicates a driving pulse for sampling and holding a noise signal with, for example, the signal holding portion disposed in the column circuit. The numbers inside the parentheses indicate the orders of the rows.

FIG. 3 shows an example of control pulses supplied to an image pickup region that can be applied to an embodiment of the present invention. FIG. 3 shows driving pulses supplied to pixels in the first and second rows. All the driving pulses come into a conducting state at a high level.

Before time T1, PRES and POFD of all the pixels on an image pickup surface are at a high level, in which a reference voltage is supplied to the gage of the amplifying transistor 15. The other control pulses in FIG. 3 are at a low level.

At time T1, PTX1 and PTXFD of all the pixels on the image pickup surface shift from a low level to a high level. At time T2, PTX1, PTXFD, and POFD of all the pixels on the image pickup surface shifts from the high level to the low level. This operation causes electrons at the photoelectric conversion unit 8 and the signal holding portion 10 to be discharged to the drain of the reset transistor 17 via the OFD region or the FD region. At time T2, an exposure period for image acquisition at the n-th frame is started. As shown in FIG. 3, the exposure period is the same across the entire image pickup surface.

At time T3, PTX1 of all the pixels on the image pickup surface shifts from the low level to the high level, and at time T4, shifts from the high level to the low level. This operation causes the electrons at the photoelectric conversion unit 8 of all the pixels on the image pickup surface to be collectively transferred to the signal holding portion 10.

At time T5, POFD of all the pixels on the image pickup surface shifts from the low level to the high level, and the electrons generated due to light incident on the photoelectric conversion unit 8 to be discharged to the OFD region.

Next, at time T6, PSEL(1) shifts from the low level to the high level, and at the same time, PRES(1) shifts from the high level to the low level. This operation allows the noise signals of the pixels to be output to vertical signal lines VOUT.

At time T7, PTN shifts from the low level to the high level, and at time T8, shifts from the high level to the low level. This operation causes a noise signal in the first row to be held at a noise-signal holding portion of the column circuit.

At time T9, PTXFD(1) shifts from the low level to the high level. At time T10, PTXFD(1) shifts from the high level to the low level. This operation causes electrons to be transferred from the signal holding portions 10 to the gates of the amplifying transistors 15 in the plurality of pixels in the first row.

At time T11, PTS shifts from the low level to the high level, and at time T12, shifts from the high level to the low level. This operation causes optical signals of the pixels at the first row to be held at the optical-signal holding portion in the column circuit. Thereafter, the signals held in the column circuit are output to the horizontal output line when receiving a horizontal scanning pulse (not shown).

At time T13, PSEL(1) shifts from the high level to the low level to bring the pixels in the first row from the selected state to the non-selected state. At the same time, PRES(1) shifts from the low level to the high level. During period T14-T21, signals of the pixels in the second row are read, as in the first row.

This operation enables global electronic shutter.

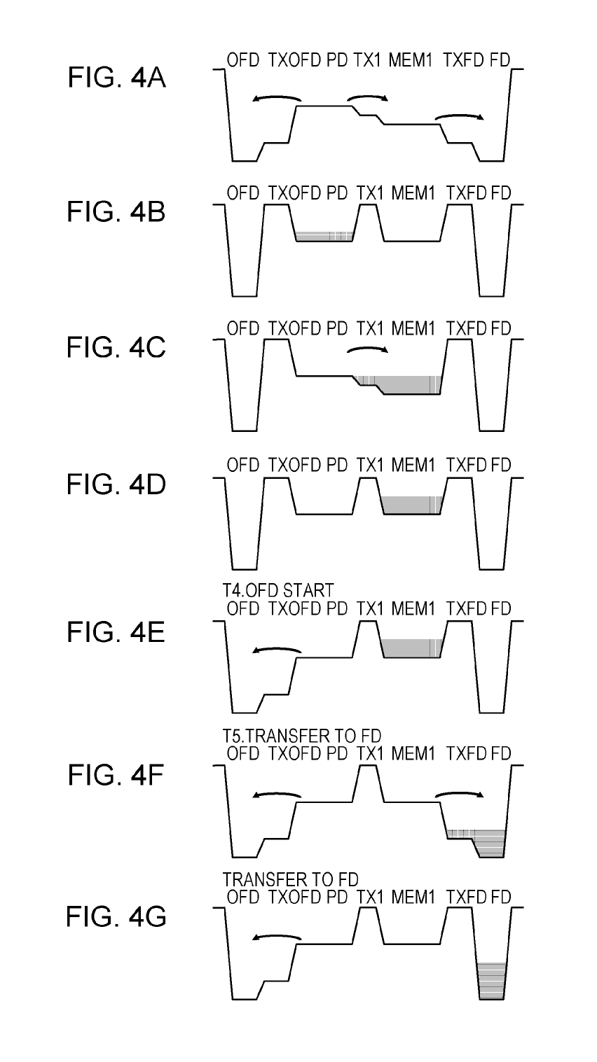

Next, FIGS. 4A to 4G show potential diagrams of a pixel that can be applied to an embodiment of the present invention.

FIG. 4A is a diagram showing the potential state during period T1-T2 in FIG. 3. As described with reference to FIG. 3, all of PTX1, PTXFD, and POFD are at the high level during period T1-T2. In other words, the potential barriers generated in all the charge transfer portions are low. The electrons generated at a photoelectric conversion unit PD may be discharged to the OFD region 112 or the drain (not shown) of the reset transistor 17 so that there are no electrons at the photoelectric conversion unit PD and a signal holding portion MEM1.

The photoelectric conversion unit PD has the highest potential for the electrons at that time. Furthermore, as shown in FIG. 4A, the potential may decrease from the photoelectric conversion unit PD to the input node FD of the amplifying element.

FIG. 4B is a potential diagram corresponding to period T2-T3 in FIG. 3. A first charge transfer portion TX1 comes into a non-conducting state, in which the potential barrier between the photoelectric conversion unit PD and the signal holding portion MEM1 is higher than that in FIG. 4A. In FIG. 4B, electrons are accumulated at the photoelectric conversion unit PD.

FIG. 4C is a potential diagram corresponding to period T3-T4 in FIG. 3. The electrons accumulated at the photoelectric conversion unit PD are transferred to the signal holding portion MEM1. To enhance the electron transfer efficiency of the photoelectric conversion unit PD, the potential barrier while the first charge transfer portion TX1 is conducting may be lower than the potential of the photoelectric conversion unit PD. Furthermore, the potential of the signal holding portion MEM1 may be lower than the potential of the photoelectric conversion unit PD. In the case where the control gate is shared by the first charge transfer portion TX1 and the signal holding portion MEM1, the potential of the signal holding portion MEM1 can be lowered by supplying a conducting pulse to the first charge transfer portion TX1.

FIG. 4D is a potential diagram corresponding to period T4-T5 in FIG. 3. The electrons at the photoelectric conversion unit PD are transferred to the signal holding portion MEM1, and the first charge transfer portion TX1 comes into a non-conducting state to cause a potential barrier at the first charge transfer portion TX1. The holding capacity of the signal holding portion MEM1 depends on the heights of the potential barriers generated at the first charge transfer portion TX1 and the second charge transfer portion TXFD. Accordingly, the potential barriers may be as high as possible to enhance the saturation of signals.

FIG. 4E is a potential diagram of the pixels in the first row, corresponding to period T5-T9, which is a waiting period during which signals are held at the signal holding portions MEM1 of the pixels in the first row until the individual pixel rows are selected, so that signals are read to the vertical signal line. During period T5-T9, TXOFD is in a conducting state, in which electrons generated at the photoelectric conversion unit PD are discharged to the OFD region. The period during which the potential is maintained depends on the pixel row. To start an exposure period of the next frame during a given-frame reading period, TXOFD may be brought into a non-conducting state to start accumulation of signals at the photoelectric conversion unit PD.

FIG. 4F is a potential diagram of the pixels in the first row corresponding to period T9-T10, in which electrons are transferred from signal holding portions MEM1 of the pixels in the first row to the input nodes FD of the amplifying elements. To enhance the electron transfer efficiency of the signal holding portion MEM1, the potential barrier of a second charge transfer portion TXFD may be lower than the potential of the signal holding portion MEM1. Furthermore, the potential of the input node FD of the amplifying element may be lower than the potential of the signal holding portion MEM1.

FIG. 4G is a potential diagram of the pixels in the first row corresponding to period T10-T13, which is a potential diagram at the time where the transfer of electrons to the input node FD of the amplifying element has been completed.

Providing the signal holding portion MEM1 between the output node of the photoelectric conversion unit PD and the input node FD of the amplifying element of each pixel in this way enables a global electronic shutter operation.

The study of the inventors shows that it is difficult to enhance the electron transfer efficiency of such a pixel configuration when transferring signal charges from the photoelectric conversion unit to the input node of the amplifying element without increasing the voltage during transfer. A conventional configuration having no signal holding portion has only one stage of an electron transfer portion from the photoelectric conversion unit to the input node of the amplifying element. However, providing an additional signal holding portion on the electric path between the output node of the photoelectric conversion unit and the input node of the amplifying element requires at least two stages of charge transfer portion. To enhance the electron transfer efficiency, the relationship among the potentials of the photoelectric conversion unit, the relationship among the potentials of the input nodes of the photoelectric conversion unit, the signal holding portion, and the amplifying element, and the charge transfer portions between them is important. For the potential relationship, both the height of the potential barrier caused by the impurity concentration of the semiconductor region and the height of the potential controlled by supplying a bias to the control electrode have to be taken into account. The inventors took on a new challenge to achieve high electron transfer efficiency at a low voltage for the configuration in which a signal holding portion is provided between the output node of the photoelectric conversion unit and the input node of the amplifying element, which has not been sufficiently studied.

An image pickup device according to an embodiment of the present invention is provided with a photoelectric conversion unit having a first-conductivity-type first semiconductor region having the same polarity as that of signal charge and a second-conductivity-type second semiconductor region. The signal holding portion includes a first-conductivity-type third semiconductor region and a control electrode disposed above the third semiconductor region via an insulator film. The second semiconductor region that constitutes the photoelectric conversion unit includes a plurality of regions disposed at different depths. The plurality of regions include a first region that forms a PN junction with the first semiconductor region, a second region disposed at a depth deeper than the first region, and a third region disposed between the first region and the second region. The impurity concentration peak P1 of the first region, the impurity concentration peak P2 of the second region, and the impurity concentration peak P3 of the third region satisfy P3<P1<P2. The depth is based on the main surface of a semiconductor substrate on which the control electrode is disposed. In the following embodiment, a so-called surface-incident-type image pickup device to which light enters from the control electrode side will be described. However, the present invention can also be applied to a so-called back-irradiation-type image pickup device to which light enters from another main surface different from the main surface on which the control electrode is disposed. Also for the back-irradiation-type image pickup device, the relationship among the depths of the components is defined by the depth based on the main surface on which the control electrode is disposed.

Embodiments of the present invention will be described in detail by using specific examples. The following description is made using electrons as signal charges. If holes are used as the signal charges, the conduction type of the semiconductor region may be reversed so that the voltage is reversed.

### First Embodiment

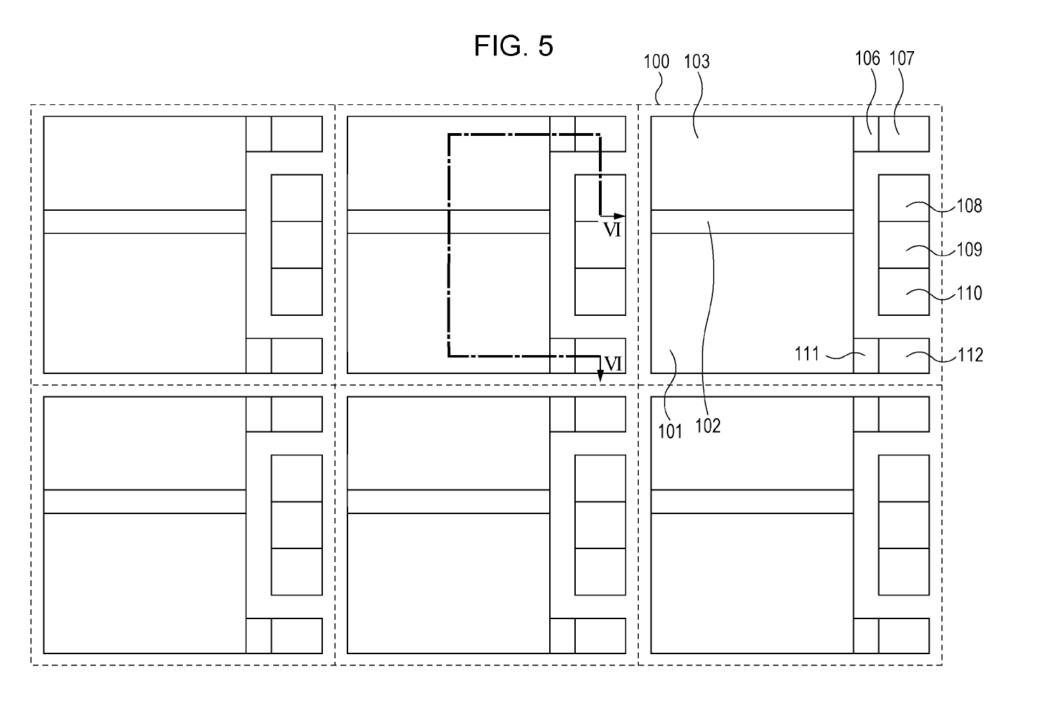

FIG. 5 is a top view of an image pickup region of an image pickup device according to a first embodiment of the present invention. Although 2- by 3-pixels, six pixels in total, are shown here, more pixels may be disposed to constitute the image pickup region.

Pixels 100 each include a photoelectric conversion unit 101, a first charge transfer portion 102, a signal holding portion 103, and a second charge transfer portion 106. The pixel 100 further includes an FD region 107, a reset transistor 108, an amplifying transistor 109, and a select transistor 110. The pixel 100 further includes a third charge transfer portion 111 and an overflow drain region (hereinafter referred to as an OFD region) 112.

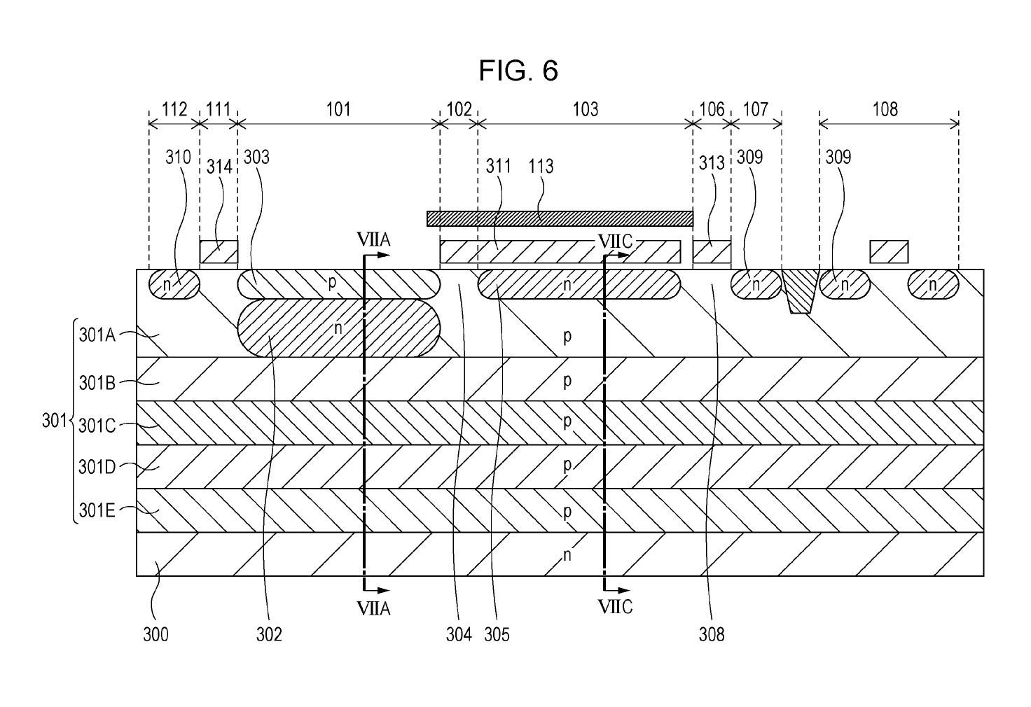

FIG. 6 shows a cross-sectional view taken along line VI-VI in FIG. 5. Components having the same functions as those in FIG. 5 are given the same reference numerals, and detailed descriptions thereof will be omitted.

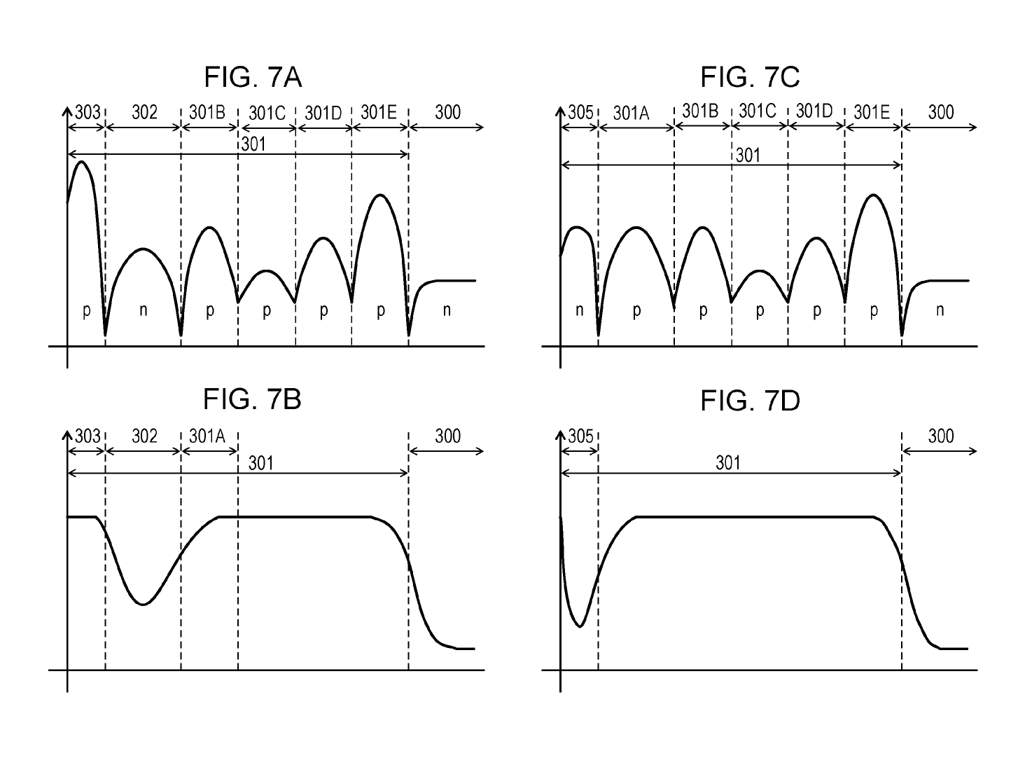

An N-type semiconductor substrate 300 is provided with a P-type semiconductor region 301. The P-type semiconductor region 301 has a plurality of regions disposed at different depths. In the first embodiment, the P-type semiconductor region 301 has five regions from a first region 301A to a fifth region 301E. In the first embodiment, the first region 301A to the fifth region 301E have impurity concentration peaks. It is characterized in the relationship among the impurity concentration peaks. The details of the relationship among the impurity concentration peaks will be described with reference to FIGS. 7A to 7D. In the first embodiment, the first region 301A to the fifth region 301E can be extended across the entire image pickup region. Although they may also be disposed in the peripheral circuit region, a P-type semiconductor region having a different impurity concentration profile from that of the image pickup region may be disposed in the peripheral circuit in consideration of the characteristics of the peripheral circuit.

An N-type semiconductor region 302 is disposed so as to form a PN junction with part of the P-type semiconductor region 301. In the first embodiment, the N-type semiconductor region 302 forms a PN junction with the first region 301A and the second region 301B of the plurality of regions that constitute the P-type semiconductor region 301. A P-type semiconductor region 303 is disposed on the surface of the N-type semiconductor region 302. The P-type semiconductor region 301, the N-type semiconductor region 302, and the P-type semiconductor region 303 constitute a so-called pinned photodiode.

Electrons generated at the photoelectric conversion unit 101 move through a first channel 304 to reach an N-type semiconductor region 305 that constitutes the signal holding portion 103. The electrons held at the N-type semiconductor region 305 move through a second channel 308 to reach an N-type semiconductor region 309 that constitutes the FD region 107. The electrons at the photoelectric conversion unit 101 can be discharged to an N-type semiconductor region 310 that constitutes the OFD region 112 via a fourth transfer gate 314.

A first control gate 311 is disposed over the first channel 304 and the N-type semiconductor region 305 via an insulator. The first control gate 311 is shared by the first charge transfer portion 102 and the signal holding portion 103.

The first charge transfer portion 102 includes the first channel 304 and part of the first control gate 311 disposed over the first channel 304 via an insulator film.

The signal holding portion 103 includes the N-type semiconductor region (third semiconductor region) 305 and the P-type semiconductor region (second semiconductor region) 301 that forms a PN junction with the N-type semiconductor region 305. In the first embodiment, the N-type semiconductor region 305 forms a PN junction with the first region 301A. Furthermore, the signal holding portion 103 includes part of the first control gate 311 disposed over the N-type semiconductor region 305 via the insulator film.

A second control gate 313 is disposed over the second channel 308 via an insulator film.

The second charge transfer portion 106 includes the second channel 308 and the second control gate 313. A light-shielding member 113 covers the top of the first charge transfer portion 102 and the signal holding portion 103. FIGS. 7A to 7D show potential diagrams of the pixels of the first embodiment.

FIG. 7A corresponds to a cross section of a portion corresponding to the photoelectric conversion unit 101, showing the impurity concentration of a portion taken along line VIIA-VIIA in FIG. 6. For example, the individual regions can be formed by ion implantation using the same mask. The regions can be formed at different depths by changing energy during ion implantation of the regions. FIG. 7B shows a potential diagram of FIG. 7A. FIG. 7C corresponds to a cross section of a portion corresponding to the signal holding portion 103, showing the impurity concentration of a portion taken along line VIIC-VIIC in FIG. 6. FIG. 7D shows a potential diagram of FIG. 7C. As is evident from FIGS. 7A and 7C, the bottom of the first semiconductor region 302 is deeper than the bottom of the third semiconductor region 305.

What is importance as the relationship among the impurity concentrations in the first embodiment is the relationship among the impurity concentration of the second region 301B, the third region 301C, and the fifth region 301E, or the relationship among the impurity concentrations of the first region 301A, the third region 301C, and the fifth region 301E. It is important that the following relationship is satisfied:

P3<P2<P5 (Exp. 1)

or

P3<P1<P5 (Exp. 2)

where P1 is the impurity concentration peak of the first region 301A, P2 is the impurity concentration peak of the second region 301B, P3 is the impurity concentration peak of the third region 301C, and P5 is the impurity concentration peak of the fifth region 301E. Both Exp. 1 and Exp 2 may be satisfied. Satisfying such relationship allows electron transfer efficiency to be enhanced without increasing the voltage during charge transfer from the photoelectric conversion unit 101 to the signal holding portion 103. The mechanism thereof will be described hereinbelow.

Electrons generated at the photoelectric conversion unit 101 accumulate at the N-type semiconductor region 302. However, electrons generated at depths deeper than a certain depth move to the N-type semiconductor substrate 300 or the photoelectric conversion units of the adjacent pixels at a certain probability. Such behavior of the electrons sometimes decreases the sensitivity of the pixels. Movement of electrons to adjacent photoelectric conversion units causes noise. If adjacent pixels correspond to different colors, color mixture occurs. To address them, the impurity concentration of the fifth region 301E is set higher than the impurity concentration of regions closer to the N-type semiconductor region 302 than the fifth region 301E, so that the fifth region 301E acts as a potential barrier to electrons, thus allowing the electrons to be returned to the N-type semiconductor region 302.

Since the third region 301C is a semiconductor region whose impurity concentration is lower than that of the fifth region 301E, the returned electrons can easily accumulate at the N-type semiconductor region 302 due to an electric field caused by the difference in impurity concentration.

The electrons accumulated at the N-type semiconductor region 302 are transferred to the signal holding portion 103 by depleting the N-type semiconductor region 302 (hereinafter referred to as depletion transfer). At that time, if the impurity concentration of a semiconductor region that forms a PN junction with the N-type semiconductor region 302 is low, the depletion layer expands, thus resulting in an increase in voltage for depleting the N-type semiconductor region 302. In contrast, the impurity concentration peak of the first region 301A or the second region 301B that forms a PN junction with the N-type semiconductor region 302 is higher than the impurity concentration peak of the third region 301C. This can suppress the depletion layer from expanding to the third region 301C of low concentration, thus preventing an increase in depletion overvoltage. The impurity concentration peaks of the first region 301A and the second region 301B may be higher than that of the third region 301C. However, it is not desirable that the impurity concentration peaks of the first region 301A and the second region 301B be higher than the impurity concentration peak of the fifth region 301E. This is because the first region 301A and the second region 301B act as potential barriers to electrons, thus preventing electrons from accumulating at the N-type semiconductor region 302. Here, the description has been made using the relationship among impurity concentration peaks on the assumption that the impurity regions are formed by general ion implantation. However, if uniform impurity concentration regions can be formed by epitaxial growth or the like, an embodiment of the present invention can be achieved by replacing the foregoing relationship among the impurity concentration peaks with the relationship among the uniform impurity concentration values.

In particular, in the case where the signal holding portion is provided between the output node of the photoelectric conversion unit and the input node of the amplifying element, as in the first embodiment, the voltage during transfer tends to increase. This is because the potential for electrons may be decreased step by step from the photoelectric conversion unit to the input node of the amplifying element, and because it is necessary to supply control pulses of greater amplitude to the control electrode and the input node of the amplifying element that constitute the charge transfer portion as the number of stages during transfer increases.

Next, the relationship among impurity concentrations at the signal holding portion MEM1 will be described using FIG. 7C, and a potential diagram corresponding thereto will be described using FIG. 7D. In the first embodiment, the P-type semiconductor region 301 extends from the photoelectric conversion unit 101 to the signal holding portion 103 via the first charge transfer portion 102. The N-type semiconductor region 305 that constitutes the signal holding portion 103 is disposed at a position shallower than the N-type semiconductor region 302 that constitutes the photoelectric conversion unit 101. The difference in depth between the N-type semiconductor regions 302 of the photoelectric conversion unit 101 and the N-type semiconductor region 305 of the signal holding portion 103 causes differences in impurity concentration distribution and potential structure.

### Second Embodiment

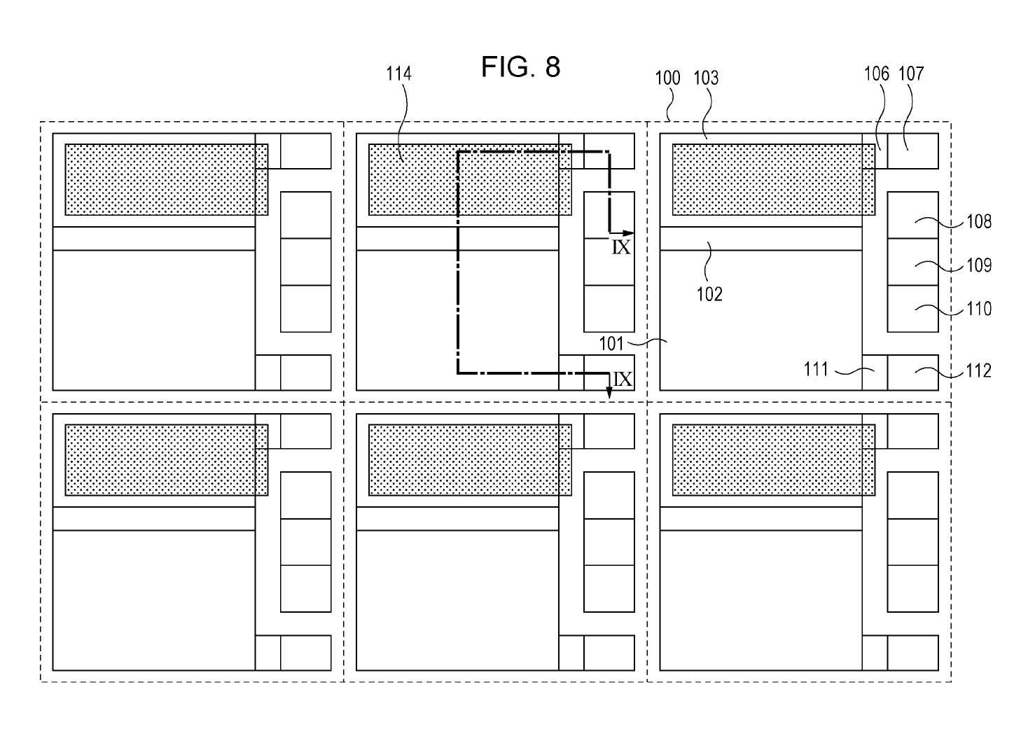

FIG. 8 shows a top view of an image pickup region of an image pickup device according to a second embodiment of the present invention. Components having the same functions as those of the first embodiment are given the same reference numerals, and detailed descriptions thereof will be omitted. A difference between the first embodiment and the second embodiment is the structure of a portion under the N-type semiconductor region 305 that constitutes the signal holding portion 103. Specifically, a P-type semiconductor region 114 is added.

As shown in FIG. 8, the P-type semiconductor region 114 is disposed so as to overlap with the signal holding portion 103 in plan view and not to overlap with the first semiconductor region 302.

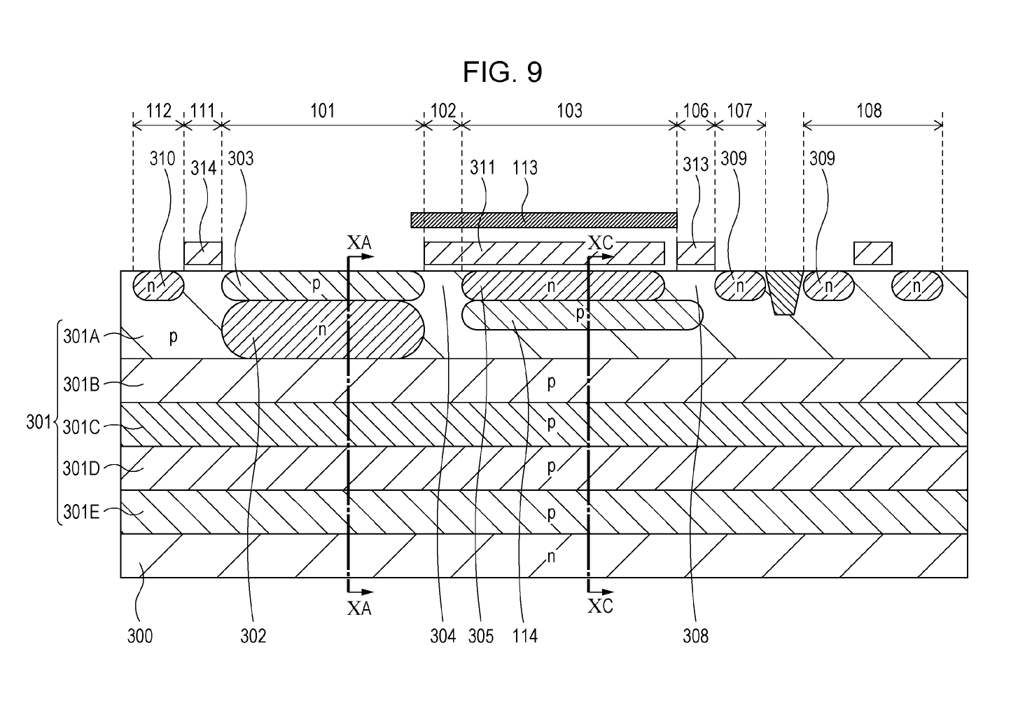

FIG. 9 shows a cross-sectional view taken along line IX-IX in FIG. 8. Components having the same functions as those of the first embodiment are given the same reference numerals, and detailed descriptions thereof will be omitted. The P-type semiconductor region 114 is disposed under the N-type semiconductor region 305 that constitutes the signal holding portion 103. The P-type semiconductor region 114 forms a PN junction with the N-type semiconductor region 305. The impurity concentration of the P-type semiconductor region 114 is higher than the impurity concentration of at least the first region 301A.

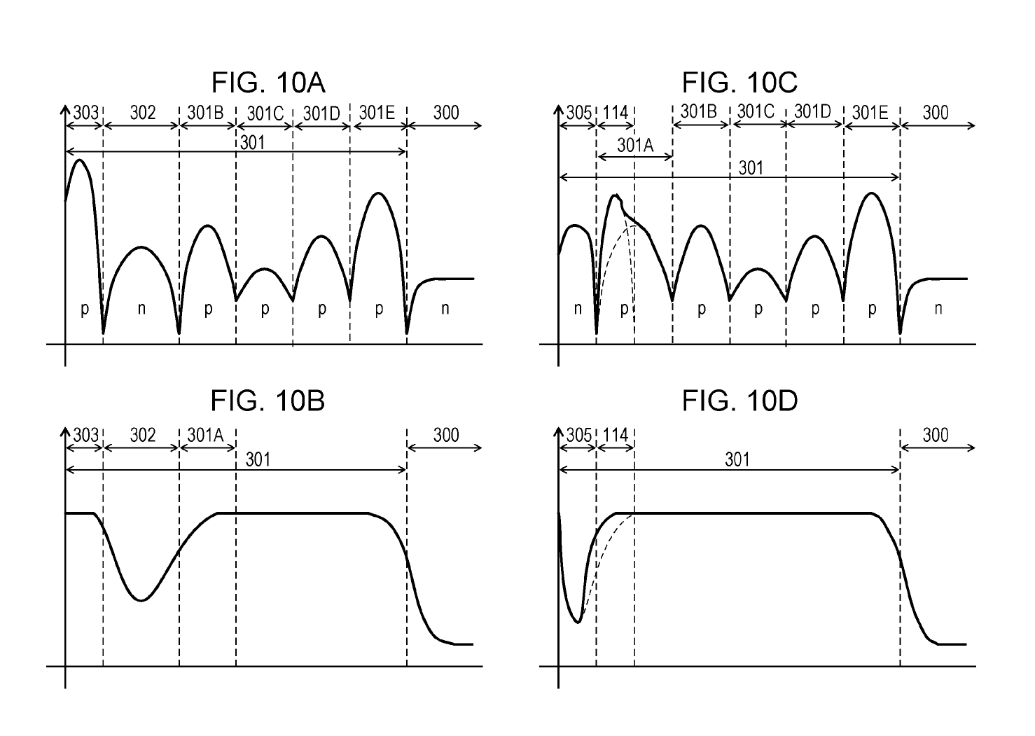

FIG. 10A shows the impurity concentration distribution of a cross section XA-XA in FIG. 9, and FIG. 10B shows a potential diagram thereof. FIG. 10C shows the impurity concentration distribution of a cross section XC-XC in FIG. 9, and FIG. 10D shows a potential diagram thereof.

Since the configuration of the photoelectric conversion unit 101 can be the same as in the first embodiment, detailed descriptions of the impurity concentration and the potential thereof will be omitted.

The dotted line shown in FIG. 10C indicates an impurity concentration with the configuration of the first embodiment. In the second embodiment, the impurity concentration of the P-type portion that forms a PN junction with the N-type semiconductor region 305 is higher than that in the first embodiment because of the P-type semiconductor region 114. Accordingly, this allows the voltage for depleting the N-type semiconductor region 305 and transferring electrons to be decreased. Furthermore, the P-type semiconductor region 114 is disposed at a position shallower than the second region 301B. Comparing the impurity concentration of N-type semiconductor region 302 that constitutes the photoelectric conversion unit 101 and the impurity concentration of the N-type semiconductor region 305 that constitutes the signal holding portion 103, the impurity concentration of the N-type semiconductor region 305 is higher. The P-type semiconductor region 114 is disposed in a shallower region of the substrate than the second region 301B.

The dotted line in FIG. 10D indicates a potential distribution with the configuration of the first embodiment. This shows that changes in potential are sharp because of the P-type semiconductor region 114.

Such a configuration allows the voltage during charge transfer from the signal holding portion 103 to be decreased while enhancing the charge holding capacity of the signal holding portion 103. The plane pattern of the P-type semiconductor region 114 is not limited to that illustrated and may be disposed in part under the N-type semiconductor region 305.

### Third Embodiment

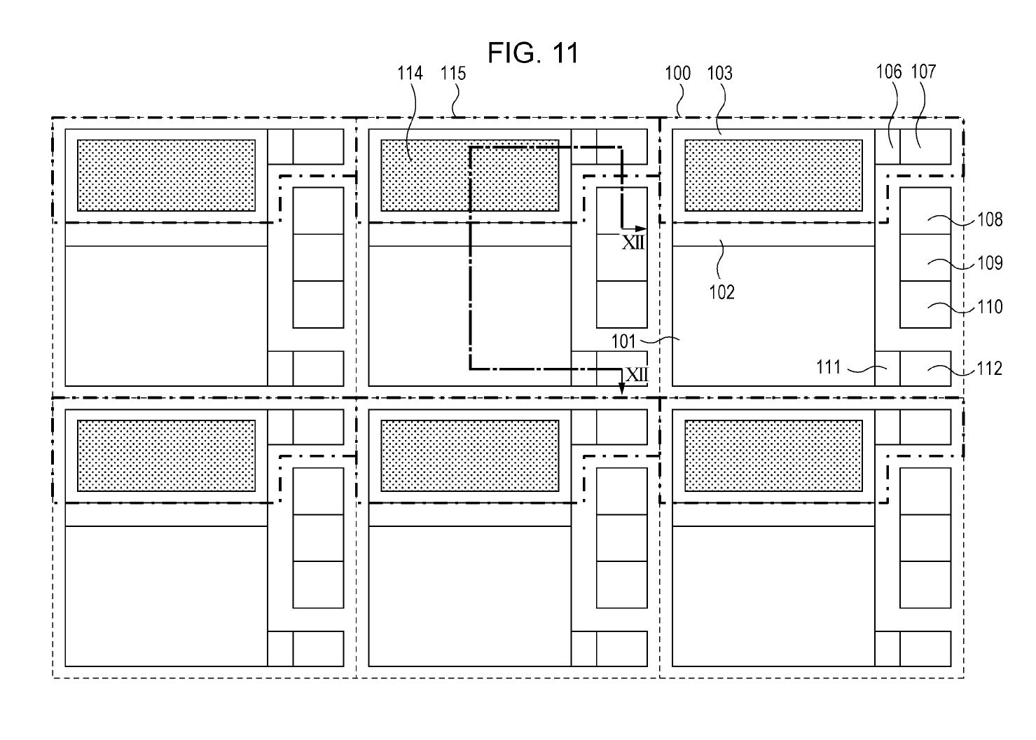

FIG. 11 shows a top view of an image pickup device according to a third embodiment of the present invention. Components having the same functions as those of the second embodiment are given the same reference numerals, and detailed descriptions thereof will be omitted.

A difference between the first and second embodiments and the third embodiment is that an N-type semiconductor region 115 for discharging electrical charges is provided below the N-type semiconductor region 305 that constitutes the signal holding portion 103.

In FIG. 11, the portion indicated by a one-dot chain line is the N-type semiconductor region 115 added in the third embodiment. In the third embodiment, the N-type semiconductor region 115 is disposed below the first charge transfer portion 102, the signal holding portion 103, the second charge transfer portion 106, and the FD region 107. However, the present invention is not limited thereto; the N-type semiconductor region 115 may be disposed below another pixel transistor. The N-type semiconductor region 115 may be continuously disposed below the signal holding portion 103 and to the N-type semiconductor region to which a predetermined voltage at which electrical charges can be discharged is supplied. This is because such a configuration allows electrons that have leaked out below the signal holding portion 103 to be easily discharged. However, it is necessary to dispose a P-type semiconductor region between the N-type semiconductor region 302 that constitutes the photoelectric conversion unit 101 and the N-type semiconductor region 305 that constitutes the signal holding portion 103.

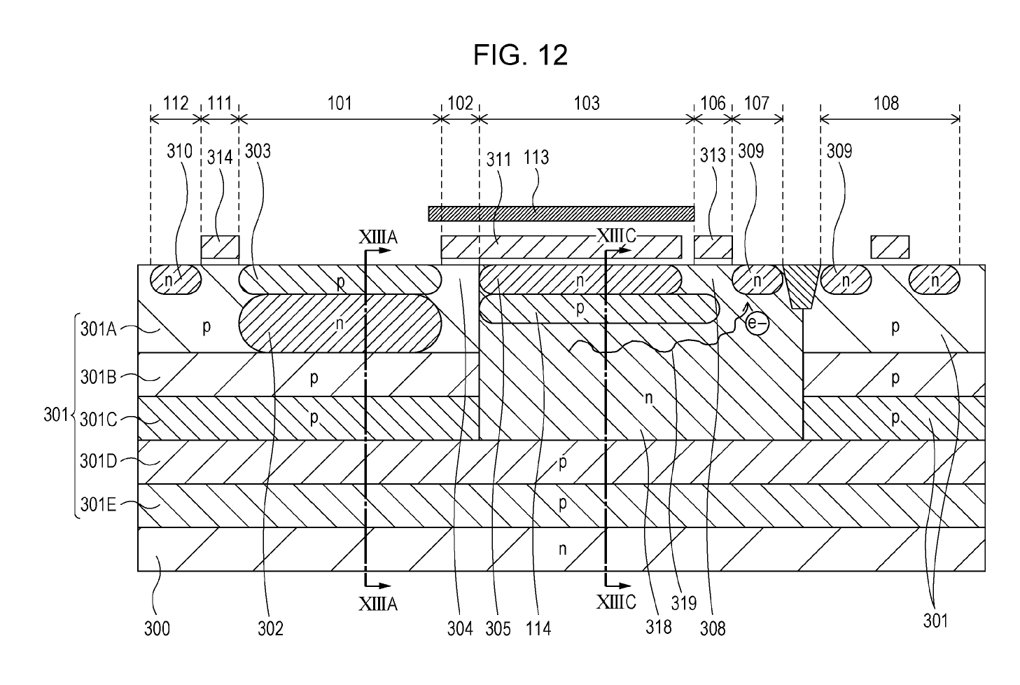

FIG. 12 shows a cross-sectional view of a pixel according to the third embodiment, which shows a cross section of a portion taken along line XII-XII in FIG. 11. Components having the same functions as those of the first and second embodiments are given the same reference numerals, and detailed descriptions thereof will be omitted.

As shown in FIG. 12, electrons present under the signal holding portion 103 leak out to signal holding portions 103 or photoelectric conversion units 101 of adjacent pixels at a certain probability. Such electrical charges cause noise, and for a pixel whose adjacent pixels correspond to different colors, color mixture occurs.

With the configuration of the third embodiment, electrons can be discharged to, for example, the N-type semiconductor region 309 that constitutes the FD region. The destination of the electrons is not limited to the FD region, as described above, and may be the source or drain region of another transistor.

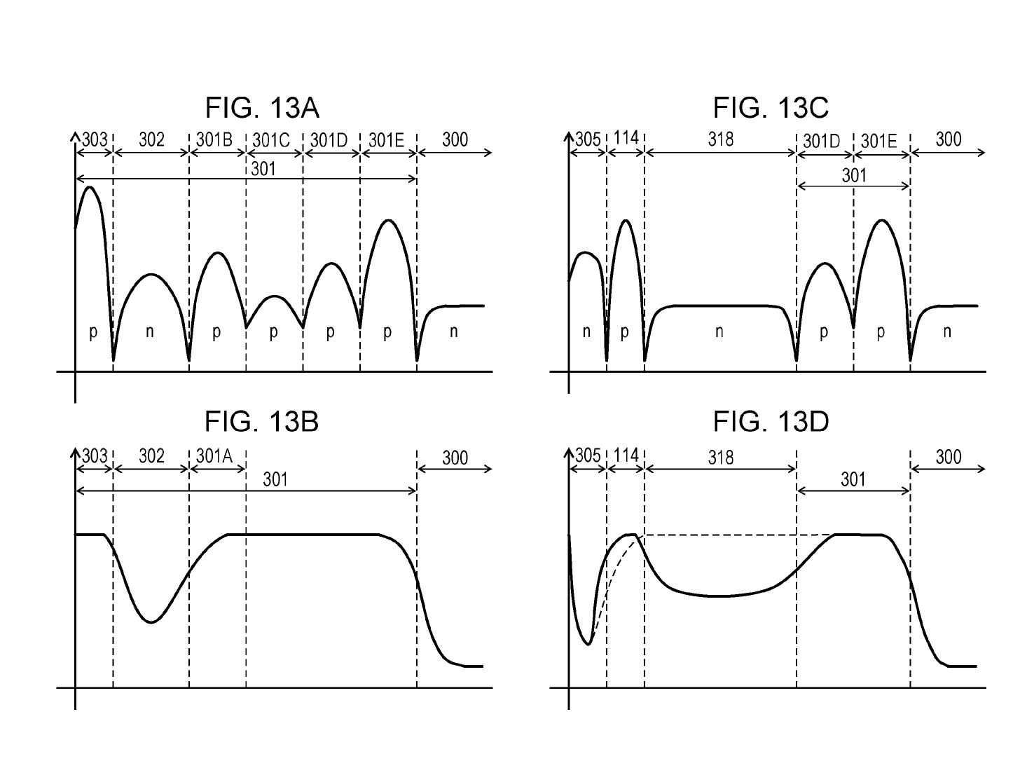

FIGS. 13A to 13D show impurity concentration distribution diagrams and potential diagrams of portions taken along line XIIIA-XIIIA and XIIIC-XIIIC in FIG. 12.

Since the configuration of the photoelectric conversion unit 101 can be the same as in the first embodiment, detailed descriptions of the impurity concentration and the potential thereof will be omitted.

As shown in FIGS. 12 and 13C, the P-type semiconductor region 114 is disposed under the N-type semiconductor region 305 that constitutes the signal holding portion 103, and an N-type semiconductor region 318 is further disposed thereunder. The impurity concentration of the N-type semiconductor region 318 is lower than the impurity concentration of the P-type semiconductor region 114. Furthermore, the impurity concentration of the N-type semiconductor region 318 is lower than the impurity concentration of the N-type semiconductor region 305.

Such a configuration allows the P-type semiconductor region 114 to function as a potential barrier between the N-type semiconductor regions 305 and 318 while decreasing the voltage when transferring electrical charges from the signal holding portion 103.

The dotted line shown in FIG. 13D indicates the potential with the configuration of the first embodiment. When compared with the configuration of the first embodiment, providing the N-type semiconductor region 318 allows a region having a low potential for electrons to be disposed below the N-type semiconductor region 305 that constitutes the signal holding portion 103. This allows electrical charges that are present below the signal holding portion 103 and that can cause noise to be quickly discharged.

### Application to Imaging System

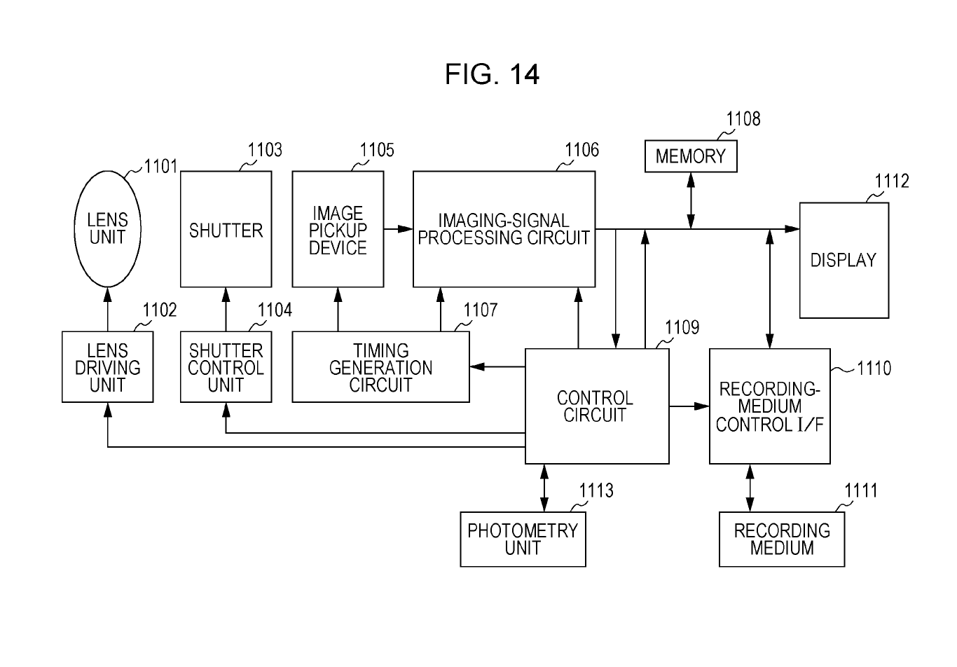

FIG. 14 shows an example of an imaging system to which the image pickup devices according to the first to third embodiments can be applied.

In FIG. 14, reference numeral 1101 denotes a lens unit that causes an image pickup device 1105 to form an optical image of a subject. A lens driving unit 1102 allows zoom control, focus control, aperture control, and so on. Reference numeral 1103 denotes a mechanical shutter, which is controlled by a shutter control unit 1104. Since global electronic shutter can be achieved with the configuration of the present invention, the mechanical shutter 1103 is not necessarily needed. However, the present invention may be configured to be able to switch between the global electronic shutter and the mechanical shutter. Reference numeral 1105 denotes an image pickup device for taking in a subject imaged by the lens unit 1101 as an image signal; and 1106 denotes an imaging-signal processing circuit that performs various corrections on an image signal output from the image pickup device 1105 or compresses data. Reference numeral 1107 denotes a timing generation circuit serving as a driving unit that outputs various timing signals to the image pickup device 1105 and the imaging-signal processing circuit 1106. Reference numeral 1109 denotes a control circuit that controls various calculations and the entire image pickup device 1105; 1108 denotes a memory for temporarily storing image data; and 1110 denotes an interface for recording into or reading from a recording medium. Reference numeral 1111 denotes a detachable recording medium, such as a semiconductor memory, for recording or reading image data; and 1112 denotes a display for displaying various items of information and picture images.

Next, the operation of a digital camera with the above-described configuration during image acquisition will be described.

When a main power source is turned on, a power source of a control system is turned on, and a power source of an imaging system circuit, such as the imaging-signal processing circuit 1106, is turned on.

When a release button (not shown) is pressed, a range calculation is performed on the basis of data from the image pickup device 1105, and the distance to the subject is calculated by the control circuit 1109 on the basis of the ranging result. Thereafter, the lens unit 1101 is driven by the lens driving unit 1102, and it is determined whether focus is achieved. If it is determined that focus is not achieved, the lens unit 1101 is driven again, and ranging is performed. The range calculation may be performed not only from the data from the image pickup device 1105 but also by a range finder (not shown).

After focus is achieved, an image pickup operation is started. After completion of the image pickup operation, the image signal output from the image pickup device 1105 is processed by the imaging-signal processing circuit 1106 and is written to the memory 1108 through the control circuit 1109. The imaging-signal processing circuit 1106 performs a sorting process, an adding process, and a select process therefor. The data accumulated in the memory 1108 is recorded in the detachable recording medium 1111, such as a semiconductor memory, through the recording medium control I/F 1110 under the control of the control circuit 1109.

Alternatively, the data may be directly input to a computer or the like via an external I/F (not shown) and may be subjected to image processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-033364, filed Feb. 17, 2012, which is hereby incorporated by reference herein in its entirety.

What is claimed is:

1. An image pickup device comprising:
a plurality of pixels including:
a photoelectric conversion unit;
an amplifying element that amplifies a signal based on a signal charge generated at the photoelectric conversion unit;
a signal holding portion disposed on an electric path between an output node of the photoelectric conversion unit and an input node of the amplifying element; and
a charge transfer portion that is disposed on an electric path between the output node of the photoelectric conversion unit and an input node of the signal holding portion and that transfers the signal charge at the photoelectric conversion unit to the signal holding portion,
wherein the photoelectric conversion unit includes
a first-conductivity-type first semiconductor region having the same polarity as that of the signal charge and a second-conductivity-type second semiconductor region;
the signal holding portion includes
a first-conductivity-type third semiconductor region and a control electrode disposed above the third semiconductor region via an insulator film, and
the second semiconductor region includes a plurality of regions disposed at different depths, the plurality of regions including
a first region that forms a PN junction with the first semiconductor region, a second region disposed at a depth deeper than the first region, and a third region disposed between the first region and the second region; and
wherein P3<P1<P2 is satisfied,
where P1 is the impurity concentration peak of the first region, P2 is the impurity concentration peak of the second region, and P3 is the impurity concentration peak P3 of the third region.

2. The image pickup device according to claim 1, wherein the signal charge is an electron, the first conductivity type is N-type, and the second conductivity type is P-type.

3. The image pickup device according to claim 1, further comprising:
an image pickup region in which the plurality of pixels are disposed; and
a peripheral circuit region disposed around the image pickup region,
wherein the second semiconductor region does not extend to the peripheral circuit region, and the peripheral circuit region is provided with a second-conductivity-type semiconductor region having an impurity concentration profile different from that of the second semiconductor region.

4. The image pickup device according to claim 1, wherein the first region forms a PN junction with the first semiconductor region at the lower part of the first semiconductor region and is disposed at a predetermined depth from the bottom of the third semiconductor region.

5. The image pickup device according to claim 4, further comprising a second-conductivity-type fourth region between the third semiconductor region and the first region, the second-conductivity-type fourth region being formed by a different process from that of the first region.

6. The image pickup device according to claim 5, wherein
P3<P4<P2 is satisfied,
where P4 is the impurity concentration peak of the fourth region.

7. The image pickup device according to claim 1, wherein
the bottom of the first semiconductor region is deeper than the bottom of the third semiconductor region; and
the impurity concentration of the first semiconductor region is lower than the impurity concentration of the third semiconductor region.

8. The image pickup device according to claim 1, wherein the signal charge of the first semiconductor region is transferred to the third semiconductor region by depleting the first semiconductor region.

9. The image pickup device according to claim 1, further comprising a fifth region between the third semiconductor region and the first region, wherein the impurity concentration of the fifth region is higher than that of the first region.

10. The image pickup device according to claim 1, wherein the fifth region is disposed so as to overlap with the signal holding portion in plan view and not to overlap with the first semiconductor region.

11. The image pickup device according to claim 1, further comprising a first-conductivity-type semiconductor region under the third semiconductor region via a second-conductivity-type semiconductor region.

12. An image pickup device comprising:
a plurality of pixels including:
a photoelectric conversion unit;
an amplifying element that amplifies a signal based on a signal charge generated at the photoelectric conversion unit;
a signal holding portion disposed on an electric path between an output node of the photoelectric conversion unit and an input node of the amplifying element; and
a charge transfer portion that is disposed on the electric path between the output node of the photoelectric conversion unit and an input node of the signal holding portion and that transfers the signal charge at the photoelectric conversion unit to the signal holding portion,
wherein the photoelectric conversion unit includes
a first-conductivity-type first semiconductor region having the same polarity as that of the signal charge and a second-conductivity-type second semiconductor region;
the signal holding portion includes
a first-conductivity-type third semiconductor region and a control electrode disposed above the third semiconductor region via an insulator film; and
the second semiconductor region includes a plurality of regions disposed at different depths, the plurality of regions including
a first region that forms a PN junction with the first semiconductor region, a second region disposed at a depth deeper than the first region, a third region disposed between the first region and the second region, and a fourth region disposed between the third semiconductor region and the first region, wherein
wherein
P3<P1<P2
and
P3<P4<P2 are satisfied,
where P1 is the impurity concentration peak of the first region, P2 is the impurity concentration peak of the second region, P3 is the impurity concentration peak P3 of the third region, and P4 is the impurity concentration peak of the fourth region;
the bottom of the first semiconductor region is deeper than the bottom of the third semiconductor region;
the impurity concentration of the first semiconductor region is lower than the impurity concentration of the third semiconductor region;
a fifth region is disposed between the third semiconductor region and the first region, the fifth region having an impurity concentration higher than that of the first region; and
the signal charge of the first semiconductor region is transferred to the third semiconductor region by depleting the first semiconductor region.
